(19) United States
(12) Patent Application Publication
(10) Pub. No.: US 2006/0059650 A1
(43) Pub. Date: Mar. 23, 2006

(54) Method of and apparatus for positively loading paint rollers

(76) Inventor: Daniel J. Fisher, McKinney, TX (US)

Correspondence Address: Michael A. O'Neil;Michael A. O'Neil, P.C., Suite 820, 5949 Sherry Lane, Dallas, TX, 75225, US

(21) Appl. No.: 11/203,713

(22) Filed: Aug. 15, 2005

Related U.S. Application Data
(60) Provisional application No. 60/611,446, filed on Sep. 20, 2004.

(51) Int. Cl. B05C 21/00; B05C 17/02

(52) U.S. Cl. 15/257.06; 15/230.11

(57) ABSTRACT

A roller tray is provided with a foot pad which receives at least one foot of a painter thereby preventing slippage of the roller tray during the loading of paint onto a paint roller. A rack is mounted on the roller tray and a pinion is operatively secured to a roller cover. The pinion meshes with the rack when the roller cover is positioned in the roller tray thereby forcing rotation of the roller cover as it is moved in the roller tray to assure uniform loading of paint onto the roller cover.

### CLAIM OF PRIORITY

This application claims priority of prior provisional Application Ser. No. 60/611,446 filed Sep. 19, 2004, the entire content of which is incorporated herein by reference.

### TECHNICAL FIELD

This invention relates to paint rollers of the type utilized in the painting of interior and exterior surfaces of homes, commercial buildings, and other structures, and more particularly to a method of and apparatus for positively and uniformly loading paint rollers with paint.

### BACKGROUND AND SUMMARY OF THE INVENTION

As is well known, paint rollers are widely used for the application of paint and similar substances to the interior walls and ceilings and to the exterior walls of homes and other dwellings, commercial buildings, and other structures. Paint rollers used for such purposes typically comprise a disposable roller cover which is supported for rotation about a nominally horizontally disposed axis. The axis is defined by a generally L-shaped rod which further includes a handle portion extending radially outwardly from the center of the roller cover. An elongated extension may be secured to the handle to facilitate the painting of ceilings, floors, etc.

The first step in the use of a paint roller for the application of paint to a surface is the loading of the roller cover with paint. This is typically accomplished utilizing a roller tray comprising a shallow sloping bottom wall surrounded by paint retaining side walls. The roller tray receives a quantity of paint after which the roller cover of the paint roller is rolled upwardly and downwardly along the sloping surface of the roller tray until the roller cover is loaded with paint. Thereafter the handle of the paint roller is employed to roll the roller cover along a surface thereby transferring paint from the roller cover to the surface.

As is well known to those skilled in the art of roller painting, currently available paint roller/roller tray systems are characterized by two distinct disadvantages. First, as the roller cover of the paint roller is rolled up and down on the sloping surface of the roller tray to load the roller cover with paint, the roller tray tends to slip on the underlying surface. Slippage of the roller tray during the loading of paint onto the roller cover is disadvantageous for at least two reasons. First, slippage of the roller tray tends to cause uneven loading of paint onto the roller cover. Second, slippage of the roller tray can cause paint to spill therefrom onto surrounding surfaces.

An even greater problem involves the fact that when the roller cover of a paint roller engages paint at the bottom of the roller tray further rolling movement of the roller cover upwardly and downwardly on the sloping surface of the roller tray becomes very difficult. This causes uneven loading of paint onto the roller cover of the paint roller which in turn leads to the uneven application of paint when the handle of the paint roller is subsequently used to roll the roller cover across a surface to be painted.

The present invention comprises a method of and apparatus for positively loading paint onto the roller covers of paint rollers which overcomes the foregoing and other difficulties which have long since characterized the prior art. In accordance with a first aspect of the invention a roller tray is provided with a foot pad upon which the painter stands during utilization of the roller tray in the loading of paint onto the roller cover of the paint roller. In this manner slippage of the roller tray during the paint loading procedure is entirely eliminated. In accordance with a second aspect of the invention the roller cover is provided with a pinion and the roller tray is provided with a rack which meshes with the pinion of the roller cover. In this manner the roller cover is forced to rotate as it is moved upwardly and downwardly along the sloping surface of the roller tray. Forced rotation of the roller cover insures uniform loading of paint from the roller tray onto the roller cover.

### BRIEF DESCRIPTION OF THE DRAWINGS

A more complete understanding of the present invention may be had by reference to the following Detailed Description when taken in connection with the accompanying Drawings, wherein:

FIG. 1 is a perspective view diagrammatically illustrating the method and apparatus of the present invention;

FIG. 2 is a side view illustrating one configuration of the roller tray of the present invention;

FIG. 3A is a longitudinal sectional view of the roller tray of the present invention illustrating one configuration of the rack thereof;

FIG. 3B is a sectional view similar to FIG. 3A illustrating a different configuration of the rack of the roller tray of the present invention;

FIG. 4A is a perspective view illustrating a first configuration of the paint roller of the present invention; and

FIG. 4B is a perspective view similar to FIG. 4A illustrating a second configuration of the paint roller of the present invention.

### DETAILED DESCRIPTION

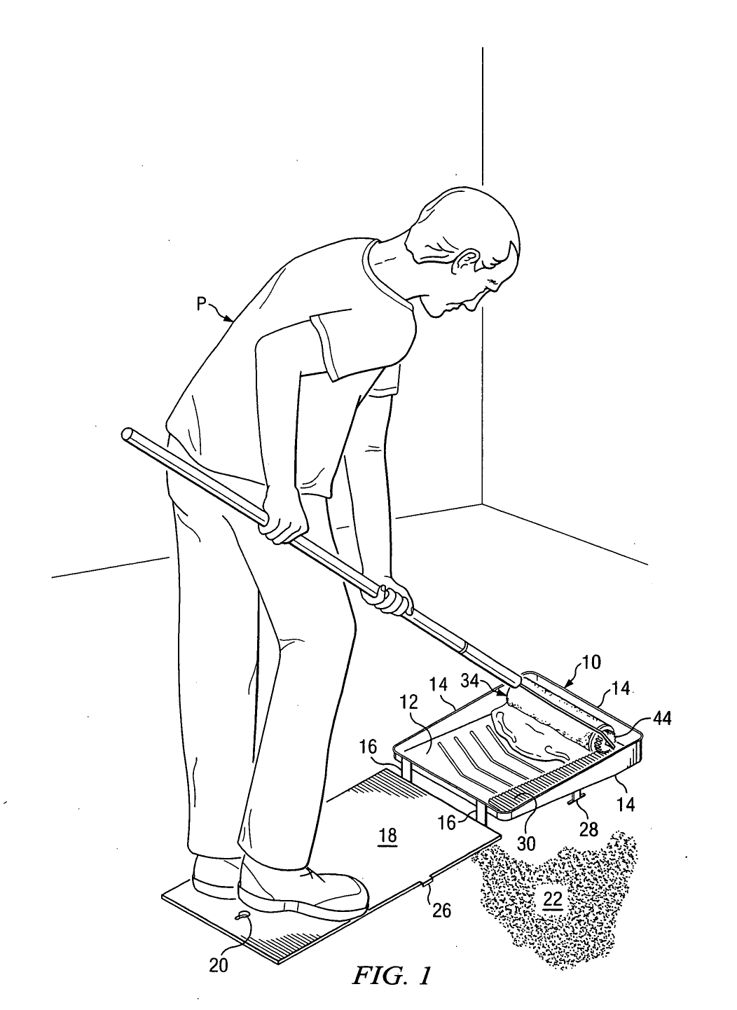

Referring now to the drawings and particularly to FIG. 1 thereof, the method and apparatus of the present invention is illustrated therein. A roller tray 10 has a downwardly sloping bottom wall 12 which is surrounded by paint retaining side walls 14. The angular orientation of the bottom wall 12 is maintained by legs 16 which extend downwardly from the upper end of the wall 12.

In accordance with the present invention a foot pad 18 is secured to the roller tray 10. For example, the foot pad 18 may be secured to the legs 16. Other configurations for attaching the foot pad 18 to the roller tray 10 will readily suggest themselves to those skilled in the art. The foot pad 18 is preferably provided with an aperture 20 which facilitates hanging of the roller tray 10 during periods of non-use.

During use the roller tray 10 including the foot pad 18 thereof is supported on a floor or other underlying surface 22. A painter P that is utilizing the roller tray 10 stands on the foot pad 18 during the loading of a paint roller with paint from the roller tray 10. In this manner the roller tray 10 is secured against slippage thereby assuring that paint from the roller tray 10 is uniformly loaded onto the paint roller.

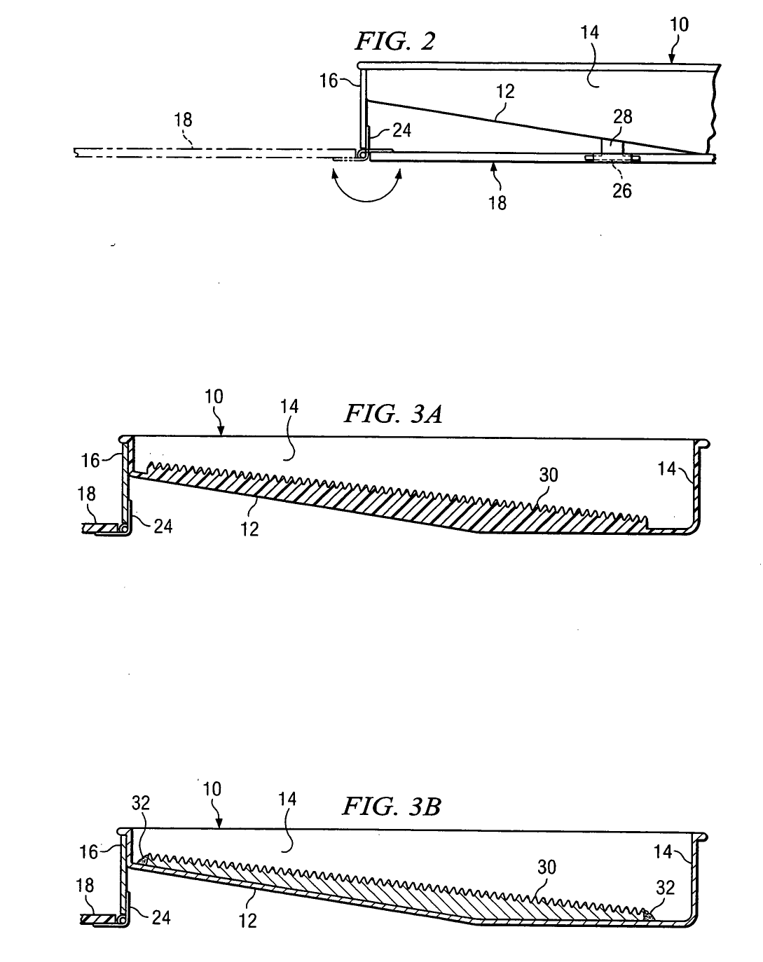

The foot pad 18 may be rigidly secured to the remaining components of the roller tray 10 such that the downwardly sloping wall 12 and the surrounding walls 14 are positioned below the foot pad 18 when the aperture 20 is used to hang the roller tray 10 for storage. Referring to FIG. 2, an alternative construction of the roller tray 10 is illustrated wherein the foot pad 18 is secured to the remaining components of the roller tray 10 by a hinge 24. When the hinge 24 is utilized, cooperating latching members 26 and 28 are utilized to secure foot pad 18 in its folded orientation thereby providing a more compact configuration of the roller tray 10 for storage.

Referring to FIGS. 1, 3A, and 3B, the roller tray 10 is provided with a rack 30 which extends along the downwardly sloping bottom wall 12 adjacent one of the side walls 14, that being the right hand side wall 14 when viewed from the perspective of the painter P in FIG. 1. FIG. 3A illustrates a molded plastic roller tray 10 wherein the rack 30 is formed integrally with the wall 12 and the walls 14 thereof. FIG. 3B illustrates a metal roller tray 10 wherein the rack 30 comprises a separate construction which is secured to the wall 12 by welding or braising as indicated at 32, by means of a suitable adhesive, or by means of suitable fasteners. In either case the rack 12 is characterized by a series of identical, evenly spaced teeth having a predetermined pitch.

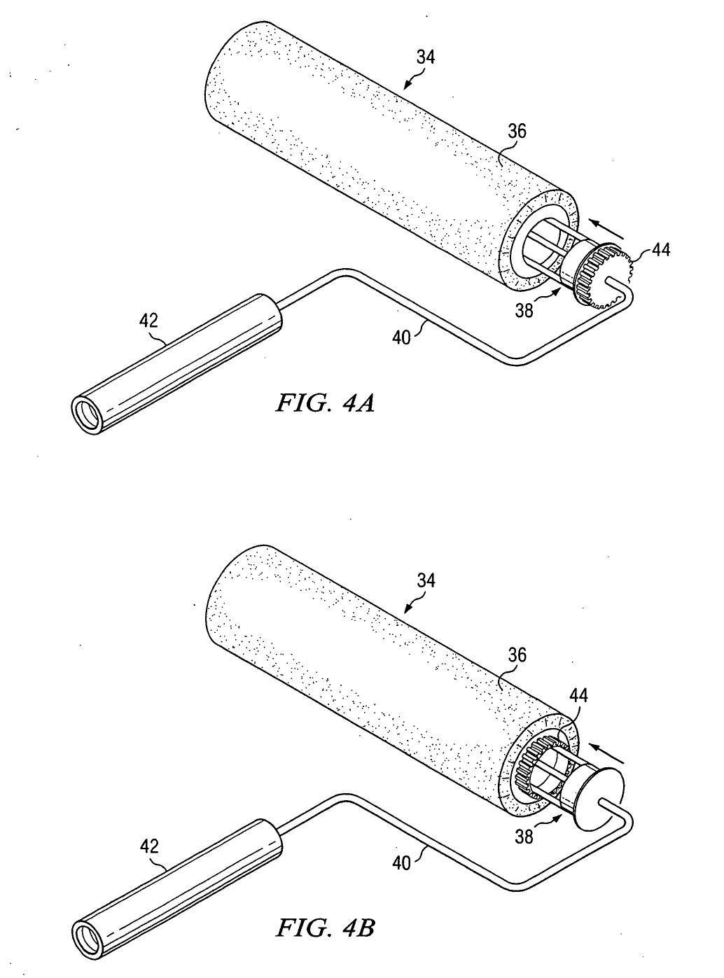

A paint roller 34 useful in the practice of the method and apparatus of the present invention is illustrated in FIGS. 1, 4A and 4B. The paint roller 34 includes a roller cover 36 which is conventional in construction and function. The roller cover 36 is received and supported on a roller assembly 38 for rotation about a nominally horizontally disposed axis. The roller assembly 38 is rotatably supported on a generally L-shaped roller handle assembly 40 including a handle 42. The handle 42 extends radially outwardly from the center of the roller cover 36 when the roller cover 36 is fully seated on the roller assembly 38.

The paint roller 34 further includes a pinion 44. In FIG. 4A the pinion comprises part of the roller assembly 38. The construction of FIG. 4A is advantageous in that it reduces the costs of replacement roller covers 36 which are generally considered as disposable. In FIG. 4B, the pinion comprises part of the roller cover 36. The configuration of FIG. 4B is advantageous in that slippage between the roller cover 36 and the roller assembly 38 is entirely prevented. In either case the pinion 44 comprises a plurality of identical, evenly spaced teeth characterized by a pitch which is identical to the pitch of the rack 30.

Referring specifically to FIG. 1, the paint roller 34 is utilized by positioning the pinion 44 in mesh with the rack 30. As the paint roller 34 is moved upwardly and downwardly along the sloping bottom wall 12 of the roller tray 10, the pinion 44 and the rack 34 force the roller cover of the paint roller 34 to rotate. This assures uniform loading of paint onto the roller cover of the paint roller 34, which in turn assures uniform painting of a surface when the roller cover of the paint roller 34 is rolled thereover.

An important feature of the invention comprises the fact that the pinion 44 is positioned at the proximal end of the roller assembly 38 and the roller cover 36 of the paint roller 34. This facilitates the use of the distal end of the roller cover 36 in the painting of corners, and the like.

Although preferred embodiments of the invention have been illustrated in the accompanying Drawings and described in the foregoing Detailed Description, it will be understood that the invention is not limited to the embodiments disclosed, but is capable of numerous rearrangements, modifications, and substitutions of parts and elements without departing from the spirit of the invention.

1. An apparatus for positively and uniformly loading paint onto paint rollers comprising:
A. a roller tray including:
1. a downwardly sloping bottom wall having a periphery;
2. a plurality of paint retaining side walls extending upwardly from the periphery of the downwardly sloping bottom wall;
3. a foot pad secured to the downwardly sloping bottom wall for engagement by a foot of a painter utilizing the roller tray and thereby preventing slippage of the roller tray during loading of paint onto a paint roller; and
4. a rack extending along the downwardly sloping bottom wall adjacent one of the side walls;
B. a paint roller including;
1. a disposable roller cover;
2. a generally L-shaped handle assembly including a handle;
3. a roller assembly rotatably supported on the generally L-shaped handle assembly;
4. A roller cover;
5. the roller assembly receiving the roller cover thereon for rotation about a nominally disposed horizontal axis; and
6. a pinion operatively secured to the roller cover for rotation therewith;
the pinion secured to the roller cover meshing with the rack of the roller tray and thereby assuring rotation of the roller cover as the roller cover is moved upwardly and downwardly on the downwardly sloping surface of the roller tray during loading of paint onto the roller cover of the paint roller.

2. The apparatus for positively and uniformly loading paint onto paint rollers according to claim 1 wherein the pinion comprises part of the roller cover.

3. The apparatus for positively and uniformly loading paint onto paint rollers according to claim 1 wherein the pinion comprises part of the roller assembly.

4. The apparatus for positively and uniformly loading paint onto paint rollers according to claim 1 wherein the foot pad is hingedly secured to the downwardly sloping bottom wall thereby enabling the footpad to fold beneath the roller tray for compact storage thereof, the foot pad maintained in its folded orientation by cooperating latching members.

5. The apparatus for positively and uniformly loading paint onto paint rollers according to claim 1 wherein the foot pad comprises an aperture for hanging the foot and roller tray for storage thereof.

6. A method of positively loading paint onto paint rollers comprising the steps of:
providing a paint receiving roller tray having a downwardly sloping bottom wall, a periphery, and a plurality of paint retaining walls extending upwardly from the periphery;
providing a rack;
supporting the rack on the downwardly sloping bottom wall of the roller tray;
providing a roller cover;
providing a generally L-shaped handle assembly including a handle;
providing a roller assembly rotatably supported on the generally L-shaped handle assembly;
receiving the roller cover on the roller assembly for rotation therewith about a nominally disposed horizontal axis;
providing a pinion;
operatively securing the pinion to the roller cover for rotation therewith;
the pinion meshing with the rack when the roller cover is positioned in the roller tray thereby forcing rotation of the roller cover during movement thereof upwardly and downwardly on the downwardly sloping surface of the roller tray and thereby positively loading paint from the roller tray onto the roller cover.

7. The method according to claim 6 including the additional steps of:
providing a foot pad;
securing the foot pad to the roller tray; and
engaging a foot of a painter utilizing the roller tray and the roller cover with the foot pad and thereby preventing slippage of the roller tray during the loading of paint onto the roller cover.

8. The method according to claim 6 wherein the wherein the pinion comprises part of the roller cover.

9. The method according to claim 6 wherein the wherein the pinion comprises part of the roller assembly.
